(19) United States
(12) Patent Application Publication
(10) Pub. No.: US 2019/0057617 A1
(43) Pub. Date: Feb. 21, 2019

(54) BLOCK TEACHING AID FOR LEARNING LANGUAGE

(71) Applicant: Hyeong Gi KIM, Osan-si, Gyeonggi-do (KR)

(72) Inventor: Hyeong Gi KIM, Osan-si, Gyeonggi-do (KR)

(21) Appl. No.: 16/080,666

(22) PCT Filed: Dec. 26, 2016
(86) PCT No.: PCT/KR2016/015261

§ 371 Date: Aug. 29, 2018

(30) Foreign Application Priority Data
Mar. 10, 2016 (KR) 10-2016-0029017
Nov. 29, 2016 (KR) 10-2016-0159925

(51) Int. Cl. G09B 19/06; G09B 5/02; G09B 1/40; G09B 1/36

(52) U.S. Cl. CPC G09B 19/06; G09B 1/36; G09B 1/40; G09B 5/02

(57) ABSTRACT

A block teaching aid for learning a language, includes: an individual letter block made individually for each of individual letters forming a particular word, wherein the individual letter block has an appearance corresponding to a shape of a corresponding letter or at least includes the shape of the corresponding letter to allow the corresponding letter to be cognitively identified; and a block storing board defining an accommodation space to accommodate individual letter blocks that form the particular word, and constituting a frame to store the individual letter blocks therein, wherein, when the individual letter blocks are coupled and assembled with each other, they match with each of partial shape elements to make a three-dimensional shape corresponding to meaning of the particular word.

### TECHNICAL FIELD

The present invention relates to a block teaching aid for learning a language. More particularly, the invention relates to a block teaching aid for learning a language, which enables a user to effectively learn words related to animals, objects and the like.

### BACKGROUND ART

Generally, there are many types of block teaching aids (or block toys). Most of the aids are configured to complete the arrangement of letters, words or sentences by appropriately arranging blocks having the shape of consonants and vowels, with letters being printed on one or both of sides of the block.

However, a conventional block teaching aid is problematic in that it is difficult for children themselves to learn correct words or sentences, because the children do not know the correct word order, grammar or meaning of a sentence.

In particular, if a user acquires the word order or grammar of a sentence through the connection of words but does not understand the correct meaning of the words, the matching of the word with the meaning of the word may not be often made easily, so that the children's ability to learn a language or a word may not be significantly improved.

That is, it is very important to simultaneously acquire and match the names and shapes of animals or objects that are mainly used in an initial stage of acquiring words. However, a block teaching aid for learning a language, which is currently available, is problematic in that learning effect focuses only on acquiring words and thereby this aid does not completely solve the above problems.

### DISCLOSURE

### Technical Problem

Accordingly, the present invention has been made keeping in mind the above problems occurring in the related art, and is intended to provide a block teaching aid for learning a language, which enables a user to effectively learn words related to animals, objects and the like.

Further, the invention is intended to provide a block teaching aid for learning a language, which links the meaning of a word and a shape corresponding to the corresponding word to be learned in a language learning process of a child, thereby improving the effect of learning word.

Furthermore, the invention is intended to provide a block teaching aid for learning a language, which enables a shape corresponding to a corresponding word to be three-dimensionally formed through the assembly of blocks (for example, blocks related to consonants and vowels of a word indicating an animal, an object or the like, or to English alphabets) of letters constituting the corresponding word.

### Technical Solution

In order to accomplish the above objects, the present invention provides a block teaching aid for learning a language, including an individual letter block made individually for each of individual letters forming a particular word, wherein the individual letter block has an appearance corresponding to a shape of a corresponding letter or at least includes the shape of the corresponding letter to allow the corresponding letter to be cognitively identified; and a block storing board defining an accommodation space to accommodate individual letter blocks that form the particular word, and constituting a frame to store the individual letter blocks therein, wherein, when the individual letter blocks are coupled and assembled with each other, they match with each of partial shape elements to make a three-dimensional shape corresponding to meaning of the particular word.

The particular word may be a word indicating an animal or an object, the word comprising words of Korean letters or English alphabet letters, and the individual letter block may be a block related to the Korean letters or a block related to the English alphabet letters.

The individual letter block and the block storing board may be made of any one of materials including a paper material, synthetic resin, an EVA (Ethylene-Vinyl Acetate Copolymer) material, a silicone material, and wood.

The block storing board may include a plurality of accommodation spaces accommodating, respectively, the individual letter blocks that form the particular word, and separately arranged in an order of letter arrangement of individual letters forming the particular word, each of the plurality of accommodation spaces may be formed to correspond to a shape and a size of an individual letter block that may be to be accommodated, and the individual letter block may be detachably coupled to a corresponding accommodation space of the block storing board.

A surface of the individual letter block may be painted or embossed to express at least one of a characteristic shape, a color, an image and a pattern related to the animal or the object corresponding to the meaning of the particular word.

At least one coupling groove may be formed on the individual letter block to couple with another individual letter block.

At least one of a coupling protrusion and a protrusion receiving groove may be further formed on the individual letter block to increase a coupling force with another individual letter block. The coupling protrusion or the protrusion receiving groove may be formed along an inner wall surface of the coupling groove.

The coupling groove may be formed on at least one of a central portion and a peripheral surface of the individual letter block.

The particular word may be a word indicating the animal, and, when the individual letter block may be utilized as a head block corresponding to a head of the corresponding animal as the partial shape element, the coupling groove may be formed on at least one of a central portion or a right side of a bottom of the individual letter block utilized as the head block.

When the individual letter block may be utilized as a torso block corresponding to a torso of the corresponding animal as the partial shape element, the coupling groove may be formed on at least one of a central portion or a left side of a top of the individual letter block utilized as the torso block, and the coupling groove formed on the central portion or the left side of the top may be coupled with the coupling groove formed on the individual letter block utilized as the head block.

When the particular word may be a word indicating a four-footed animal that may walk with four feet, at least one coupling groove may be further formed on a left side and a right side of a bottom of the individual letter block utilized as the torso block, and the coupling groove of the torso block formed on the left side and the right side of the bottom may be coupled with the coupling groove formed on a central portion of a top of the individual letter block utilized as a leg block.

When the particular word may be a word indicating a four-footed animal capable of walking erect, at least one coupling groove may be further formed on a left side and a right side of the top of the individual letter block utilized as the torso block, or on a left side and a right side of a bottom of the individual letter block utilized as the head block, and the additionally formed coupling groove may be coupled with the coupling groove formed on the individual letter block utilized as an arm block or a wing block.

When the individual letter block may be utilized as a tail block corresponding to a tail of the corresponding animal as the partial shape element, a coupling groove formed on the individual letter block utilized as the tail block may be coupled with at least one coupling groove that is formed on any one of the right side of the top, the right side of the bottom, and a rear surface of the bottom of the individual letter block utilized as the torso block.

When the individual letter block may be utilized as an ear block corresponding to an ear of the corresponding animal as the partial shape element, the coupling groove may be formed on a central portion of a bottom of the individual letter block utilized as the ear block, and the coupling groove formed on the individual letter block utilized as the ear block may be coupled with the coupling groove formed on the top of the individual letter block utilized as the head block.

When the individual letter block may be utilized as a neck block corresponding to a neck of the corresponding animal as the partial shape element, at least one coupling groove may be formed on a central portion of a top and a central portion of a bottom of the individual letter block utilized as the neck block, and the individual letter blocks utilized as the head block and the torso block may be coupled with each other via the individual letter block utilized as the neck block.

The head block may express a face shape of the corresponding animal on the individual letter block that may be to be placed first, so as to match with the individual letter block related to an individual letter that may be placed first in an order of letter arrangement of the corresponding word.

Each of the individual letter block and the block storing board may be implemented as an electronic image object to enable a user to learn words in online or mobile environment.

### Advantageous Effects

The present invention provides a block teaching aid for learning a language, which enables a user to effectively learn words related to animals, objects and the like, and links the meaning of a word and a shape corresponding to the corresponding word to be learned in a language learning process of a child, thereby improving the effect of learning word.

Further, the invention provides a block teaching aid for learning a language, which enables a shape corresponding to a corresponding word to be three-dimensionally formed through the assembly of blocks (for example, blocks related to consonants and vowels of a word indicating an animal, an object or the like, or to English alphabets) of letters constituting the corresponding word.

### DESCRIPTION OF DRAWINGS

FIG. 1 is a perspective view illustrating a block teaching aid for learning a language according to a first embodiment in a state before individual letter blocks are separated from each other.

FIG. 2 is an exemplary view illustrating a process in which the individual letter blocks are separated and then assembled in the block teaching aid for learning the language according to the first embodiment of the present invention.

FIG. 3 is an exemplary view illustrating a state in which the individual letter blocks have been assembled in the block teaching aid for learning the language according to the first embodiment of the present invention.

FIG. 4 is a perspective view illustrating a block teaching aid for learning a language according to a second embodiment in a state before individual letter blocks are separated from each other.

FIG. 5 is an exemplary view illustrating a process in which the individual letter blocks are separated and then assembled in the block teaching aid for learning the language according to the second embodiment of the present invention.

FIG. 6 is an exemplary view illustrating a state in which the individual letter blocks have been assembled in the block teaching aid for learning the language according to the second embodiment of the present invention.

FIGS. 7 to 10 are exemplary views illustrating processes in which individual letter blocks are assembled in block teaching aids for learning languages according to respective different embodiments of the present invention.

### BEST MODE

Hereinafter, embodiments of the invention will be described in detail with reference to the accompanying drawings. The drawings are attached hereto to help explain exemplary embodiments of the invention, and the present invention is not limited to the drawings and embodiments. In the drawings, some elements may be exaggerated, reduced in size, or omitted for clarity or conciseness.

Since the present invention will be changed in various ways and have various embodiments, particular embodiments will be illustrated in the accompanying drawings and described in detail in the following description. However, it is to be understood that the present invention is not limited to any particular embodiment and embraces all changes, substitutes or equivalence without departing from the spirit or scope of the present invention.

In the following description of the present invention, when it is determined that the detailed description of the related art makes the invention obscure, it will be omitted herein. Further, numbers (e.g. first, second, etc.) used in the description of the invention are intended to merely distinguish one component from another component.

When the term “couple” or “connect” is used in the following description, it is intended to mean not only “directly coupled or connected to” but also “indirectly coupled or connected to” such as connected through another intervening element, unless otherwise specifically indicated.

According to an embodiment of the present invention, a block teaching aid for learning a language includes an individual letter block made individually for each of individual letters forming a particular word, and a block storing board defining an accommodation space to accommodate individual letter blocks that form the particular word and constituting a storing frame to store the individual letter blocks therein

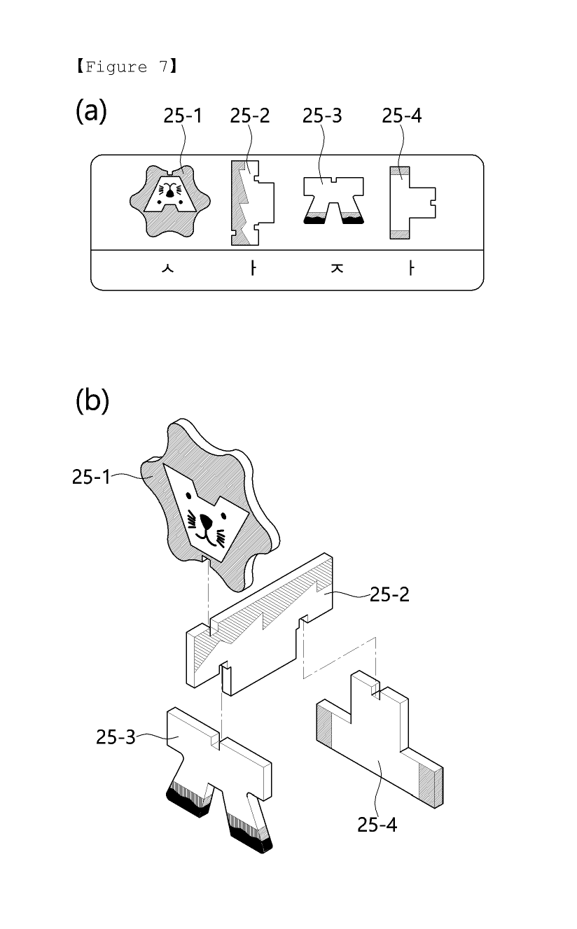

Here, the individual letter block may have an appearance corresponding to a shape of a corresponding letter or other appearances (see individual letter block 25-1 of FIG. 7) at least including the shape of the corresponding letter to allow the corresponding letter to be cognitively identified.

Further, at least one coupling groove may be formed on the individual letter block to couple with another individual letter block. The coupling groove may be formed on at least one of a central portion and a peripheral surface of the individual letter block. According to another embodiment, at least one of a coupling protrusion and a protrusion receiving groove may be further formed on the individual letter block to increase a coupling force when the individual letter block is coupled with another individual letter block. The coupling protrusion or the protrusion receiving groove may be formed along an inner wall surface of the coupling groove.

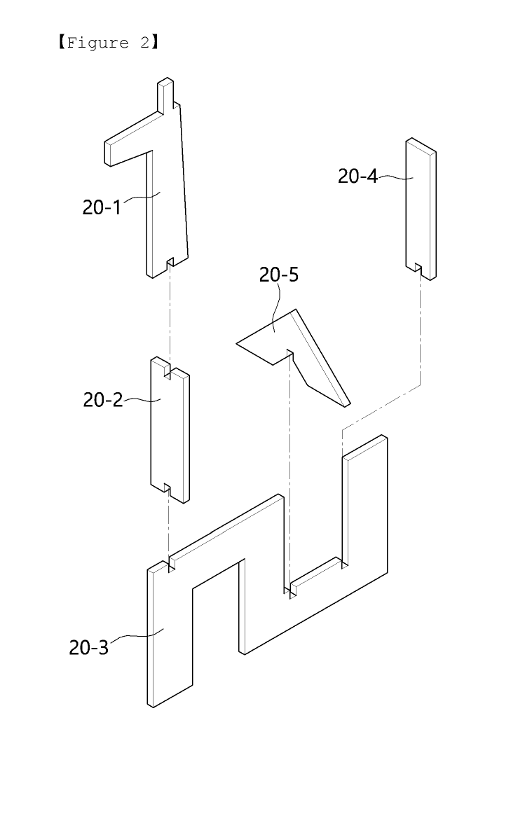

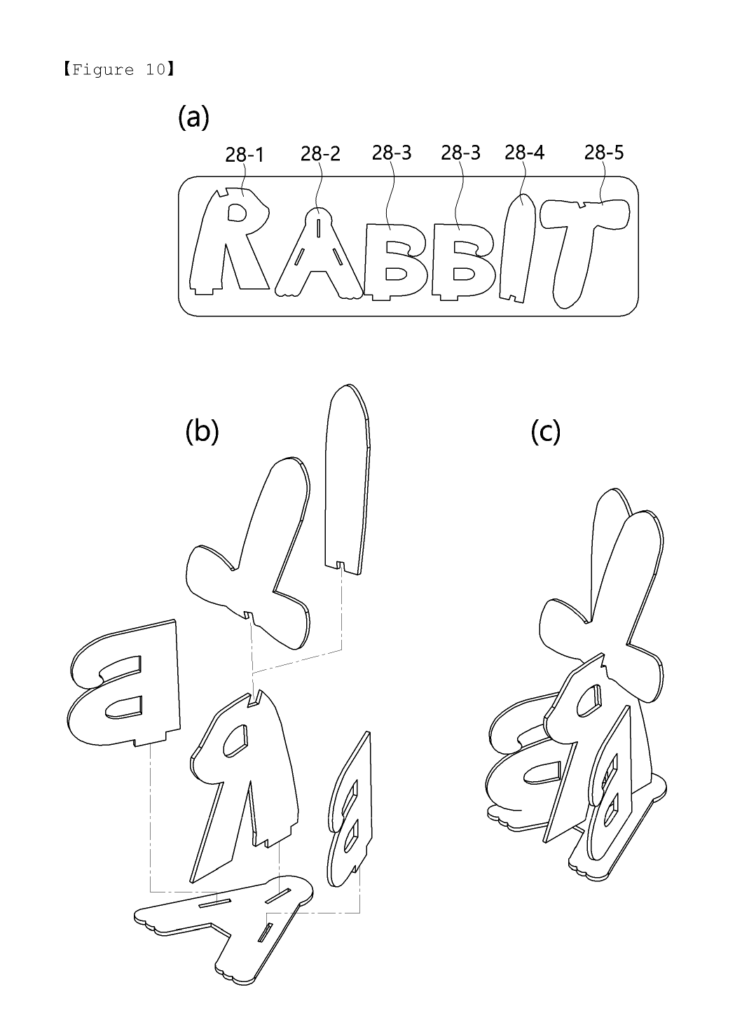

Although the method of coupling the blocks via the coupling groove will be described herein, other coupling methods may be of course applied to couple the individual letter blocks with each other. For example, as coupling means that substitute for the coupling groove at a position where the coupling groove is to be formed or at another position, a magnet, a stud (e.g. protrusion for coupling blocks with each other in the Lego block), or a through slit (see through slits formed on individual letter blocks 27-3 of FIG. 9 and 28-2 of FIG. 10) may be used. Further, although a configuration where the coupling means is provided on the individual letter block itself will be described herein, the coupling means may be provided separately from the individual letter block.

Thus, in the block teaching aid for learning the language according to the embodiment of the present invention, when the individual letter blocks are coupled to be assembled with each other, a three-dimensional shape corresponding to the meaning of a particular word that is to be learned is created. Here, the respective individual letter blocks match with respective partial shape elements forming a shaped three-dimensional structure one by one.

Thus, the block teaching aid for learning the language according to the embodiment of the present invention allows a user to effectively learn a word related to an animal, an object, etc., and links the meaning of a word and a shape corresponding to the corresponding word to be learned in a language learning process of a child, thereby improving the effect of learning word.

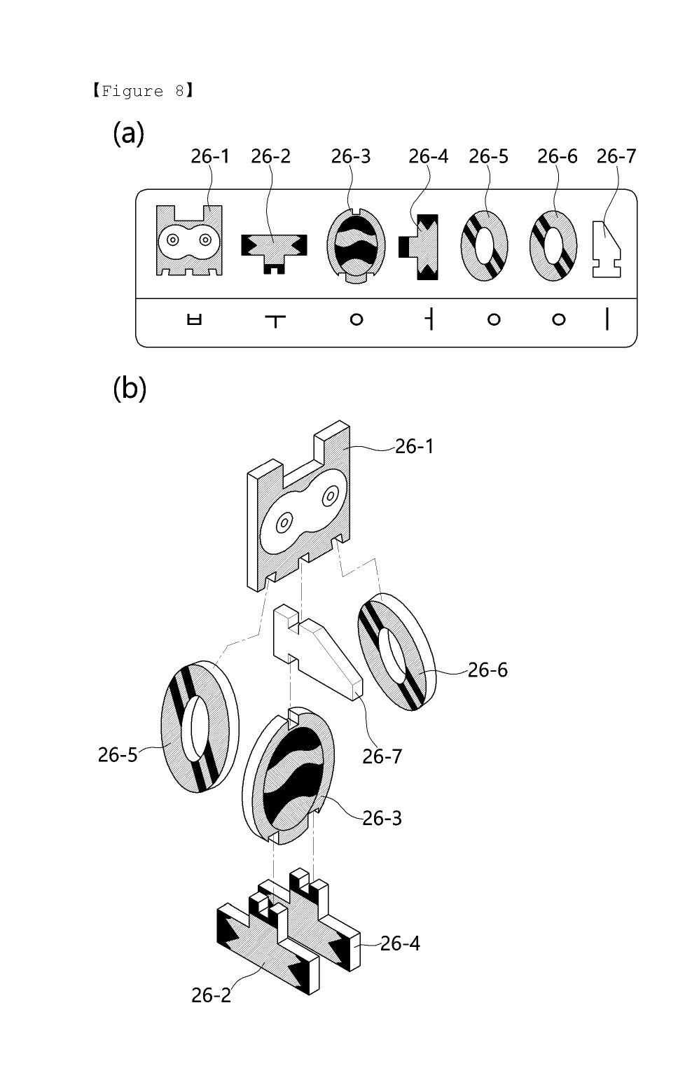

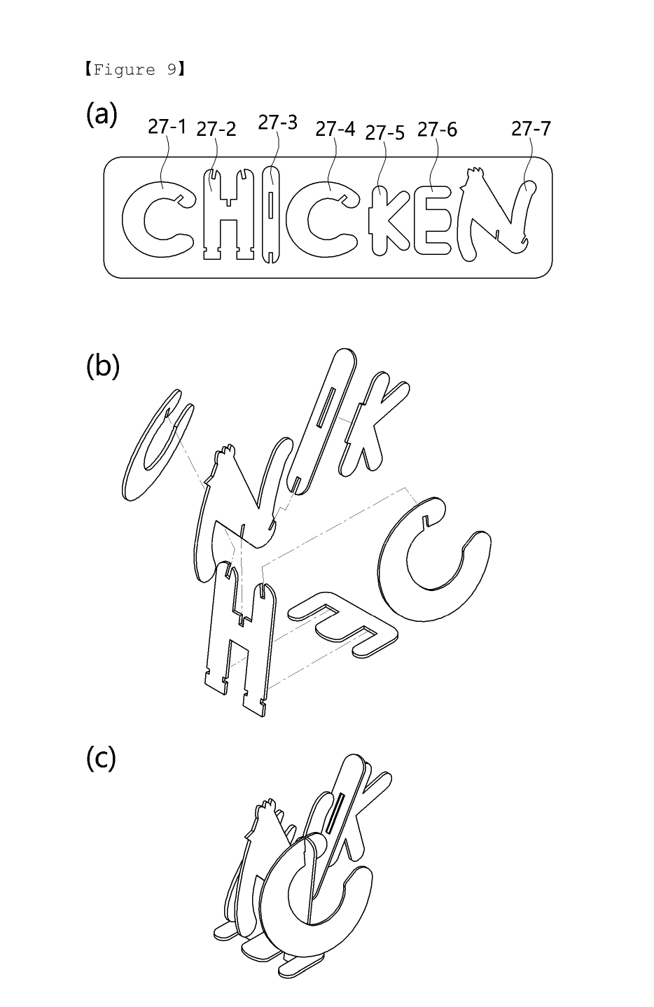

In order to further improve the word learning effect, a surface of the individual letter block may be subjected to a particular treatment (e.g. painting or embossing treatment) to express at least one of a characteristic shape, color, image and pattern related to the animal or object corresponding to the meaning of the particular word (see FIGS. 7 and 8). As such, when the surface of the individual letter block is painted or embossed, it is possible to express the shape of the animal or the object more realistically, and to enable children to easily grasp the word corresponding to the animal or the object as long as they merely look at the pattern, thus significantly improving learning effect.

Further, according to the embodiment, the aid may be preferably manufactured such that the individual letter block utilized as a head of the animal may match with the individual letter block related to an individual letter that is placed first in an order of letter arrangement of the corresponding word, and a face shape of the corresponding animal may be expressed on the individual letter block that is to be placed first. The reason is because the head of the animal is a region that best represents the characteristics of the corresponding animal, from the cognitive point of view, and the method of placing the head first enables children to quickly and easily recognize the corresponding animal.

The above-described block teaching aid for learning the language according to the embodiment of the present invention and the principle of learning the word using the aid will be clearly understood when reading the following detailed description with reference to the accompanying drawings.

Exemplary embodiments of the present invention will be described below in more detail with reference to the accompanying drawings.

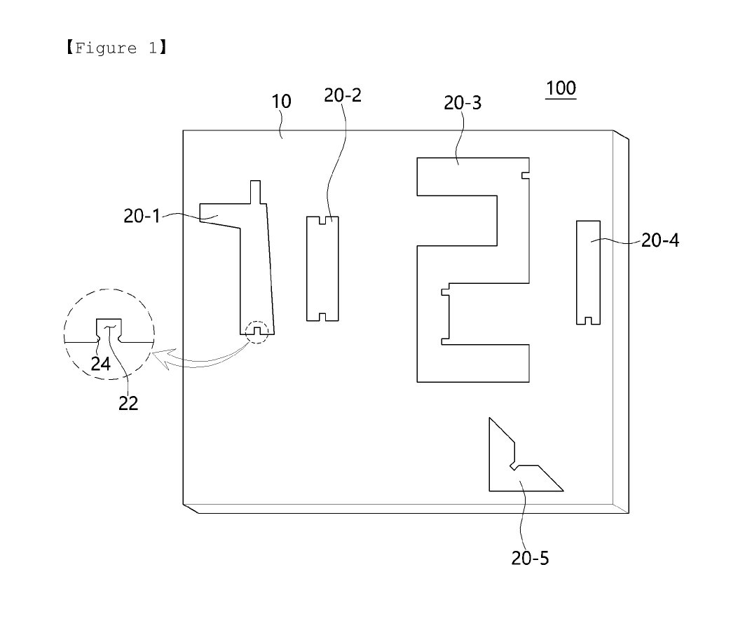

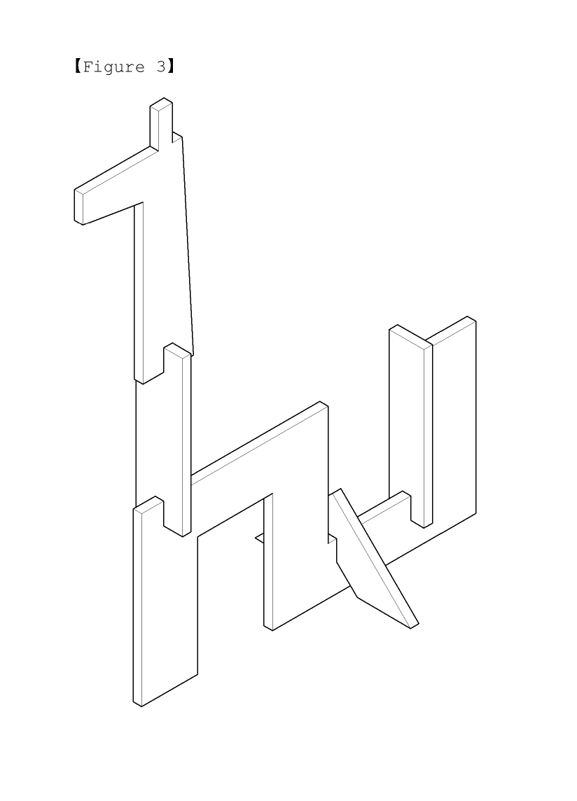

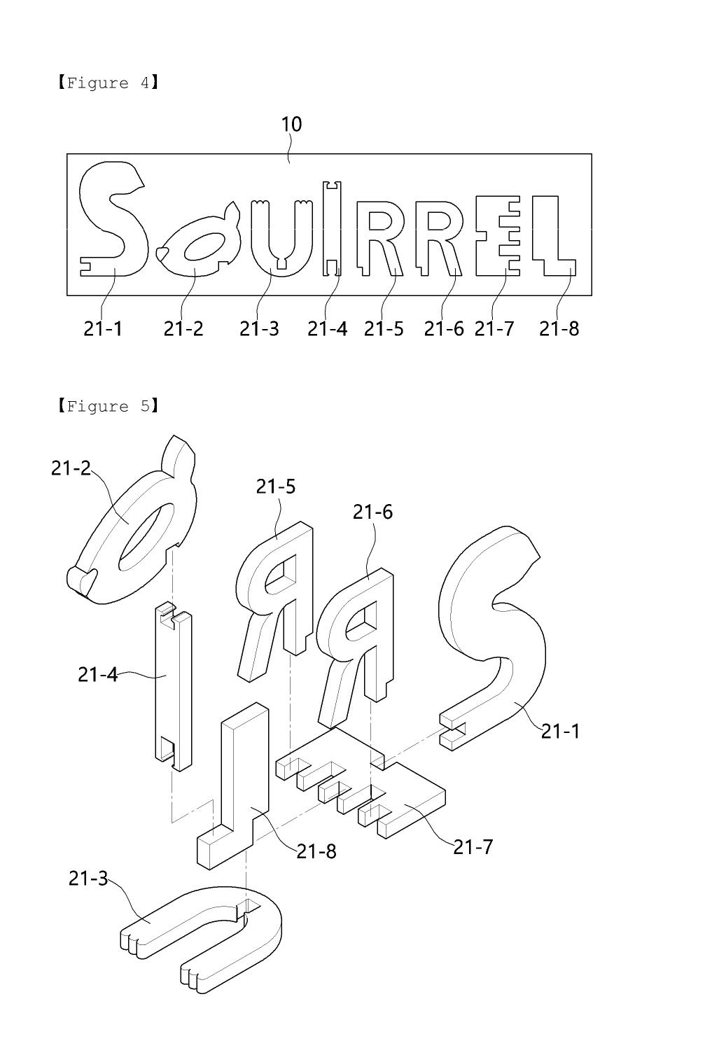

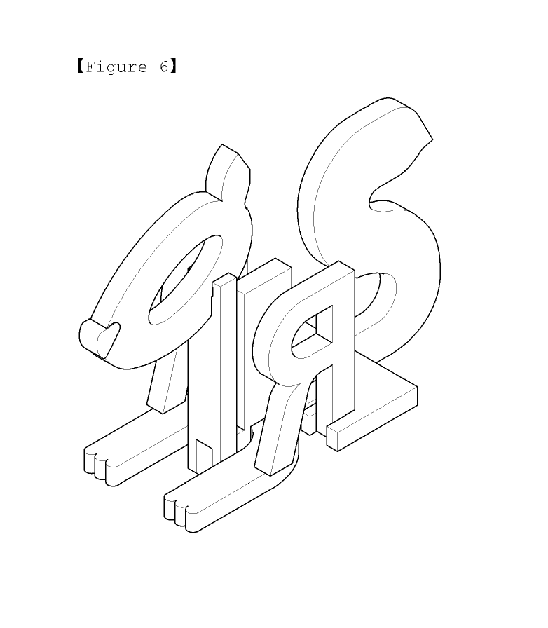

Here, FIG. 1 is a perspective view illustrating a block teaching aid for learning a language according to a first embodiment in a state before individual letter blocks are separated from each other, FIG. 2 is an exemplary view illustrating a process in which the individual letter blocks are separated and then assembled in the block teaching aid for learning the language according to the first embodiment of the present invention, and FIG. 3 is an exemplary view illustrating a state in which the individual letter blocks have been assembled in the block teaching aid for learning the language according to the first embodiment of the present invention. Further, FIG. 4 is a perspective view illustrating a block teaching aid for learning a language according to a second embodiment in a state before individual letter blocks are separated from each other, FIG. 5 is an exemplary view illustrating a process in which the individual letter blocks are separated and then assembled in the block teaching aid for learning the language according to the second embodiment of the present invention, and FIG. 6 is an exemplary view illustrating a state in which the individual letter blocks have been assembled in the block teaching aid for learning the language according to the second embodiment of the present invention. Further, FIGS. 7 to 10 are exemplary views illustrating processes in which individual letter blocks are assembled in block teaching aids for learning languages according to respective different embodiments of the present invention.

Although the block teaching aid for learning the language related to Korean words (FIGS. 1 to 3, 7 and 8) and English words (FIGS. 4 to 6, 9 and 10) is illustrated in the accompanying drawings, the learning principle of the block teaching aid for learning the language that will be described below may be of course applied to the word learning process for languages or letters other than Korean (or Korean letters) and English (or English alphabet letters). Further, although the accompanying drawings illustrate several words corresponding to animals, it is apparent to those skilled in the art that the principle of the present invention may be equally or similarly applied to various animals and objects.

First, referring to FIGS. 1 to 3, the block teaching aid for a Korean word, ‘ [symbol] ’ (which is transliterated to “KIRIN” and is translated into “giraffe” in English) is illustrated as an example of the block teaching aid for learning the language according to the first embodiment. In FIG. 1, the block teaching aid 100 for the Korean word, ‘ [symbol] ’ (which is transliterated to “KIRIN” and is translated into “giraffe” in English) includes five individual letter blocks 20-1, 20-2, 20-3, 20-4 and 20-5 that form the Korean word ‘ [symbol] ’ (which is transliterated to “KIRIN” and is translated into “giraffe” in English) and a block storing board 10 that serves as a storing frame to store (or arrange) the five individual letter blocks.

As illustrated in FIG. 1, the block storing board 10 is provided with accommodation spaces that accommodate the individual letter blocks 20-1, 20-2, 20-3, 20-4 and 20-5, respectively. Since each accommodation space is formed to correspond to the shape and the size of an individual letter block that is to be accommodated, each individual letter block may be detachably accommodated in the corresponding accommodation space.

Further, the respective accommodation spaces provided on the block storing board 10 may be separately arranged in the arrangement order of the individual letters forming a particular word. For example, referring to FIG. 1, it can be seen that the individual letters forming the Korean word ‘ [symbol] ’ (which is transliterated to “KIRIN” and is translated into “giraffe” in English) include ‘ [symbol] ’, ‘ [symbol] ’, ‘ [symbol] ’, ‘ [symbol] ’ and ‘ [symbol] ’, and the respective accommodation spaces for accommodating the individual letter blocks are arranged in the arrangement order (letter arrangement method peculiar to the Korean language, namely, order of initial consonant/medial/final consonant in FIG. 1) of the individual letters when the individual letter blocks 20-1, 20-2, 20-3, 20-4 and 20-5 for the respective individual letters are arranged. As the letter arrangement order of another example, the respective accommodation spaces provided on the block storing board 10 may be arranged in a row in the arrangement order of the individual letters (see the arrangement order of the English alphabet letter in FIG. 4, and the letter arrangement order conforming to the writing order of the Korean letter in FIG. 8A).

The individual letter blocks and the block storing board are made of any one of materials including a paper material, synthetic resin, an EVA (Ethylene-Vinyl Acetate Copolymer) material, a silicone material, and wood.

Each of the individual letter blocks 20-1, 20-2, 20-3, 20-4 and 20-5 may be detached (separated) from the block storing board 10. That is, each of the individual letter blocks 20-1, 20-2, 20-3, 20-4 and 20-5 may be connected with the block storing board 10 while its peripheral surface is substantially cut or a part of the peripheral surface is in point contact with the board.

Further, it can be seen that at least one coupling groove 22 is formed on the peripheral surface of each of the individual letter blocks 20-1, 20-2, 20-3, 20-4 and 20-5. The coupling groove 22 is used to three-dimensionally assemble the shape of an animal corresponding to the meaning of the corresponding word by coupling the individual letter blocks with each other.

Here, a coupling protrusion 24 and/or a protrusion receiving groove (not shown) may be formed on an inner wall surface of the individual letter block having the coupling groove 22 so as to prevent the coupled blocks from being undesirably separated from each other. In this regard, the coupling protrusion 24 and the protrusion receiving groove are not necessarily formed. In other words, they may be or not be formed according to design requirements or a manufacturer's selection.

The coupling protrusion 24 and the protrusion receiving groove are formed to stably maintain a coupled state after the individual letter blocks are coupled with each other via the coupling groove 22. The coupling protrusion 24 and the protrusion receiving groove may be formed in at least one pair along the inner wall surface having the coupling groove 22 to face each other.

The coupling groove 22 may be changed in its forming position according to which partial shape element each individual letter block is utilized as in a three-dimensional assembly process. Hereinafter, the forming position of the coupling groove 22 will be described in detail with reference to the drawings of each embodiment. The vertical and horizontal directions that will be described below are based on a direction where each individual letter block is arranged when the three-dimensional shape is created by assembling the individual letter blocks with each other.

First, referring to FIGS. 1 to 3, reference numeral 20-1 denotes the individual letter block that corresponds to the individual letter ‘ [symbol] ’ in the Korean word ‘ [symbol] ’ (which is transliterated to “KIRIN” and is translated into “giraffe” in English) and is utilized as the partial shape element corresponding to the head of the corresponding animal, reference numeral 20-2 denotes the individual letter block that corresponds to the individual letter ‘ [symbol] ’ in the Korean word ‘ [symbol] ’ (which is transliterated to “KIRIN” and is translated into “giraffe” in English) and is utilized as the partial shape element corresponding to the neck of the corresponding animal, and reference numeral 20-3 denotes the individual letter block that corresponds to the individual letter ‘ [symbol] ’ in the Korean word ‘ [symbol] ’, (which is transliterated to “KIRIN” and is translated into “giraffe” in English) and is utilized as the partial shape element corresponding to the torso and four limbs of the corresponding animal. Further, reference numeral 20-4 denotes the individual letter block that corresponds to the individual letter ‘ [symbol] ’ in the Korean word ‘ [symbol] ’ (which is transliterated to “KIRIN” and is translated into “giraffe” in English) and supports to make the three-dimensionally shaped animals (i.e., [symbol] ) (which is transliterated to “KIRIN” and is translated into “giraffe” in English) stably stand.

Further, referring to FIGS. 4 to 6, the block teaching aid 100 for learning the language concerning an English word, ‘SQUIRREL’ includes eight individual letter blocks 21-1, 21-2, 21-3, 21-4, 21-5, 21-6, 21-7 and 21-8 for respective individual letters forming the corresponding word. By assembling the individual letter blocks with each other, the shape of the squirrel may be three-dimensionally expressed as illustrated in FIG. 6.

Here, reference numeral 21-1 denotes an individual letter block that corresponds to the individual letter ‘S’ and is utilized as the partial shape element corresponding to a tail of the corresponding animal, reference numeral 21-2 denotes an individual letter block that corresponds to the individual letter ‘Q’ and is utilized as the partial shape element corresponding to a head of the corresponding animal, reference numeral 21-3 denotes an individual letter block that corresponds to the individual letter ‘U’ and is utilized as the partial shape element corresponding to a leg of four limb of the corresponding animal, reference numeral 21-4 denotes an individual letter block that corresponds to the individual letter ‘I’ and is utilized as the partial shape element corresponding to a neck and a belly in a torso of the corresponding animal, reference numerals 21-5 and 21-6 denote individual letter blocks that correspond to the individual letter ‘R’ and are utilized as the partial shape element corresponding to an arm of the four limbs of the corresponding animal, and reference numerals 21-7 and 21-8 denote individual letter blocks that correspond to the individual letters ‘E’ and ‘L’ and are utilized as the partial shape element corresponding to the torso of the corresponding animal.

In FIGS. 7 to 10, FIG. 7 illustrates four individual letter blocks 25-1 to 25-4 corresponding to a Korean word ‘ [symbol] ’ (which is transliterated to “SAJA” and is translated into “lion” in English), FIG. 8 illustrates seven individual letter blocks 26-1 to 26-7 corresponding to a Korean word ‘ [symbol] ’ (which is transliterated to “BUEONG-I” and is translated into “owl” in English), FIG. 9 illustrates seven individual letter blocks 27-1 to 26-7 corresponding to an English word ‘CHICKEN’, and FIG. 10 illustrates six individual letter blocks 28-1 to 28-6 corresponding to an English word ‘RABBIT’.

According to the embodiment of the present invention, when the individual letter block is utilized as a block corresponding to the head of the corresponding animal as the partial shape element, the coupling groove may be formed on at least one of a central portion or a right side of a bottom of the individual letter block utilized as the head block. Here, reference numeral 20-1 of FIG. 2 shows an example in which the coupling groove is formed on the central portion of the bottom, and reference numeral 21-2 of FIGS. 4 and 5 show an example in which the groove is formed on the right side of the bottom.

Further, according to the embodiment, when the individual letter block is utilized as a block corresponding to the neck of the corresponding animal as the partial shape element, the coupling groove may be formed on at least one of a central portion of a top or a central portion of a bottom of the individual letter block utilized as the neck block (see 20-2 of FIG. 2 or 26-7 of FIG. 8). Here, the coupling groove formed on the central portion of the top may be coupled with the coupling groove formed on the bottom of the individual letter block (see 20-1 of FIG. 2 or 26-1 of FIG. 8) utilized as the head block, and the coupling groove formed on the central portion of the bottom may be coupled with the coupling groove formed on the top of the individual letter block (see 20-3 of FIG. 2 or 26-3 of FIG. 8) utilized as the torso block.

Further, according to the embodiment, when the individual letter block is utilized as a block corresponding to the torso of the corresponding animal as the partial shape element, the coupling groove may be formed on at least one of a central portion or a left side of the top of the individual letter block utilized as the torso block. Here, reference numeral 21-4 of FIG. 5 and reference numeral 26-3 of FIG. 8 show an example in which the coupling groove is formed on the central portion of the top (case of a four-footed animal capable of walking erect), and reference numeral 25-2 of FIG. 7 shows an example in which the coupling groove is formed on the left side of the top (case of an animal walking with four feet). Here, the exemplary coupling groove that is to be formed on the torso block may be used to couple it with the head block or the neck block.

According to the embodiment, at least one coupling groove may be further formed on the left side and the right side of the bottom of the individual letter block utilized as the torso block. Here, reference numeral 25-2 of FIG. 7 and reference numeral 26-3 of FIG. 8 show an example in which the coupling groove is formed on each of the left side and the right side of the bottom. The exemplary coupling groove that is to be formed on each of the left side and the right side of the bottom of the torso block may be used to couple it with the leg block. Here, the coupling groove corresponding to the exemplary coupling groove may be formed on the central portion of the top of the leg block (see 26-2 and 26-4 of FIG. 8).

Further, according to the embodiment, at least one coupling groove may be further formed on the left side and the right side of the top of the individual letter block utilized as the torso block or on the left side and the right side of the bottom of the individual letter block utilized as the head block. Here, reference numeral 27-2 of FIG. 9 shows an example in which the coupling groove is formed on each of the left side and the right side of the top of the torso block. Further, reference numeral 26-1 of FIG. 8 shows an example in which the coupling groove is formed on each of the left side and the right side of the bottom of the head block. Here, the exemplary coupling groove may be coupled with the coupling groove that is formed on the individual letter block (see 27-1 and 27-4 of FIG. 9 or 26-5 and 26-6 of FIG. 8) utilized as the arm block or the wing block.

According to the embodiment, the coupling groove formed on the individual letter block (21-1 of FIG. 5) utilized as the tail block may be coupled with the coupling groove formed on the individual letter block (21-7 of FIG. 5) utilized as the torso block. Here, the coupling groove of the individual letter block utilized as the torso block may be formed on at least one of the right side of the top, the right side of the bottom, and a rear surface of the bottom of the corresponding individual letter block.

Further, according to the embodiment, at least one coupling groove may be further formed on the central portion of the bottom of the individual letter block (see 28-5 and 28-6 of FIG. 10) utilized as the ear block. Here, the coupling groove formed on the individual letter block utilized as the ear block may be coupled with the coupling groove formed on the top of the individual letter block (28-1 of FIG. 10) utilized as the head block.

Although the block teaching aids for learning the languages according to various embodiments of the present invention have been described herein, the learning principle of the block teaching aid for learning the language according to the embodiment of the present invention may be equally or similarly applied to an online or mobile learning method.

That is, children may assemble the digitally imaged block teaching aid on a display screen in online or mobile environment, instead of directly assembling the block teaching aid for learning the language by hand. For example, the same word learning effect can be achieved using a method in which image objects of the respective individual letter blocks (see 20 and 30 of FIG. 1) in the block storing board (see 10 of FIG. 1) that is visualized and displayed on a display screen of an electronic device such as a PC, a tablet PC, or a smartphone are separated and then are sequentially assembled to make a three-dimensional shape corresponding to a corresponding word.

In this regard, the operation of separating and assembling the image objects of the individual letter blocks may be performed by various user input interfaces such as mouse point or touch input.

In more detail, the block assembling process in the online or mobile environment may be performed as follows.

First, a user accesses a corresponding homepage and registers. Subscribed information is stored in a database. When registering, it is possible to enter the age, sex, hobby and others of a child. If the child has been registered, a language learning process in a menu bar of the homepage is clicked.

When the screen moves to the language learning process, the child clicks on any desired one among animals or objects to select it. For example, when the child selects [symbol] (which is transliterated to “KIRIN” and is translated into “giraffe” in English) among various animals in a Korean mode, a voice signal may be transmitted from a control unit (not shown) to a user's PC so as to transmit the pronunciation of the word ‘ [symbol] ’ (which is transliterated to “KIRIN” and is translated into “giraffe” in English) through a speaker. Here, the pronunciation of the word ‘ [symbol] ’ (which is transliterated to “KIRIN” and is translated into “giraffe” in English) is previously stored in the database by an administrator, and the picture of a giraffe is also stored in the database.

The control unit displays to place the picture of the giraffe at a certain position on the screen.

Subsequently, if the child drags the corresponding word through the mouse point or touch input, the individual letter block may be separated from the block storing board. The separated individual letter block may be conveniently arranged on the screen by the child.

When the arrangement has been completed, the child drags and assembles the individual letter blocks to resemble the shape of the giraffe while looking at the picture of the giraffe. Here, the younger the child is, the more difficult the assembly process is. Thus, a submenu may be further configured to allow a user to separately click on instructions for assembling the giraffe.

If the shape of the giraffe has been completed using the individual letter blocks, the control unit may transmit the voice signal, ‘ [symbol] ’ (which is transliterated to “KIRIN” and is translated into “giraffe” in English) through the user's speaker to repeat the word learning process. Further, if it is desired to learn another word, the user clicks a next-step menu to change the screen to a menu about animals or English.

As described above, according to the embodiment of the present invention, it is possible to provide very high learning ability, creativity and interest to 3 to 8-year-old children who are learning Korean and English, thereby providing a great satisfaction to children and their parents.

Furthermore, the above-described block teaching aid 100 for learning the language according to the embodiment of the present invention allows children who are learning Korean and English to read Korean and English words and assemble to shape the corresponding animal or object corresponding to the meaning of the word, thus improving a current learning method that focuses only on the word learning and enabling children to efficiently match words with objects. As a result, it is possible to greatly improve the learning effect.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A block teaching aid for learning a language, comprising:
an individual letter block made individually for each of individual letters forming a particular word, wherein the individual letter block has an appearance corresponding to a shape of a corresponding letter or at least includes the shape of the corresponding letter to allow the corresponding letter to be cognitively identified; and
a block storing board defining an accommodation space to accommodate individual letter blocks that form the particular word, and constituting a frame to store the individual letter blocks therein,
wherein, when the individual letter blocks are coupled and assembled with each other, they match with each of partial shape elements to make a three-dimensional shape corresponding to meaning of the particular word.

2. The block teaching aid of claim 1, wherein the particular word is a word indicating an animal or an object, the word comprising words of Korean letters or English alphabet letters, and
the individual letter block is a block related to the Korean letters or a block related to the English alphabet letters.

3. The block teaching aid of claim 1, wherein the individual letter block and the block storing board are made of any one of materials including a paper material, synthetic resin, an EVA (Ethylene-Vinyl Acetate Copolymer) material, a silicone material, and wood.

4. The block teaching aid of claim 1, wherein the block storing board comprises a plurality of accommodation spaces accommodating, respectively, the individual letter blocks that form the particular word, and separately arranged in an order of letter arrangement of individual letters forming the particular word,
each of the plurality of accommodation spaces is formed to correspond to a shape and a size of an individual letter block that is to be accommodated, and
the individual letter block is detachably coupled to a corresponding accommodation space of the block storing board.

5. The block teaching aid of claim 1, wherein a surface of the individual letter block is painted or embossed to express at least one of a characteristic shape, a color, an image and a pattern related to the animal or the object corresponding to the meaning of the particular word.

6. The block teaching aid of claim 1, wherein at least one coupling groove is formed on the individual letter block to couple with another individual letter block.

7. The block teaching aid of claim 6, wherein at least one of a coupling protrusion and a protrusion receiving groove is further formed on the individual letter block to increase a coupling force with another individual letter block.

8. The block teaching aid of claim 7, wherein the coupling protrusion or the protrusion receiving groove is formed along an inner wall surface of the coupling groove.

9. The block teaching aid of claim 6, wherein the coupling groove is formed on at least one of a central portion and a peripheral surface of the individual letter block.

10. The block teaching aid of claim 6, wherein the particular word is a word indicating the animal,
when the individual letter block is utilized as a head block corresponding to a head of the corresponding animal as the partial shape element,
the coupling groove is formed on at least one of a central portion or a right side of a bottom of the individual letter block utilized as the head block.

11. The block teaching aid of claim 6, wherein, when the individual letter block is utilized as a torso block corresponding to a torso of the corresponding animal as the partial shape element,
the coupling groove is formed on at least one of a central portion or a left side of a top of the individual letter block utilized as the torso block, and
the coupling groove formed on the central portion or the left side of the top is coupled with the coupling groove formed on the individual letter block utilized as the head block.

12. The block teaching aid of claim 11, wherein, when the particular word is a word indicating a four-footed animal that walks with four feet,
at least one coupling groove is further formed on a left side and a right side of a bottom of the individual letter block utilized as the torso block, and
the coupling groove of the torso block formed on the left side and the right side of the bottom is coupled with the coupling groove formed on a central portion of a top of the individual letter block utilized as a leg block.

13. The block teaching aid of claim 11, wherein, when the particular word is a word indicating a four-footed animal that is capable of walking erect,
at least one coupling groove is further formed on a left side and a right side of the top of the individual letter block utilized as the torso block, or on a left side and a right side of a bottom of the individual letter block utilized as the head block, and
the additionally formed coupling groove is coupled with the coupling groove formed on the individual letter block utilized as an arm block or a wing block.

14. The block teaching aid of claim 11, wherein, when the individual letter block is utilized as a tail block corresponding to a tail of the corresponding animal as the partial shape element,
a coupling groove formed on the individual letter block utilized as the tail block is coupled with at least one coupling groove that is formed on any one of the right side of the top, the right side of the bottom, and a rear surface of the bottom of the individual letter block utilized as the torso block.

15. The block teaching aid of claim 11, wherein, when the individual letter block is utilized as an ear block corresponding to an ear of the corresponding animal as the partial shape element,
the coupling groove is formed on a central portion of a bottom of the individual letter block utilized as the ear block, and
the coupling groove formed on the individual letter block utilized as the ear block is coupled with the coupling groove formed on the top of the individual letter block utilized as the head block.

16. The block teaching aid of claim 11, wherein, when the individual letter block is utilized as a neck block corresponding to a neck of the corresponding animal as the partial shape element,
at least one coupling groove is formed on a central portion of a top and a central portion of a bottom of the individual letter block utilized as the neck block, and
the individual letter blocks utilized as the head block and the torso block are coupled with each other via the individual letter block utilized as the neck block.

17. The block teaching aid of claim 6, wherein the head block expresses a face shape of the corresponding animal on the individual letter block that is to be placed first, so as to match with the individual letter block related to an individual letter that is placed first in an order of letter arrangement of the corresponding word.

18. The block teaching aid of claim 1, wherein each of the individual letter block and the block storing board is implemented as an electronic image object to enable a user to learn words in online or mobile environment.
